(19) United States
(12) Patent Application Publication
(10) Pub. No.: US 2020/0353604 A1
(43) Pub. Date: Nov. 12, 2020

(54) Hex Key Radial Foldout Hand Tool

(71) Applicant: Robert Joseph Gallegos, Fremont, CA (US)

(72) Inventor: Robert Joseph Gallegos, Fremont, CA (US)

(21) Appl. No.: 16/868,045

(22) Filed: May 6, 2020

Related U.S. Application Data
(60) Provisional application No. 62/844,191, filed on May 7, 2019.

(51) Int. Cl. B25B 15/00; B25G 1/08; B25B 15/02; B25B 23/00; B25G 3/38

(52) U.S. Cl. CPC B25B 15/008; B25G 1/085; B25G 3/38; B25B 23/0028; B25B 15/02

(57) ABSTRACT

Generally continuous cylindrical body where a first set of tools and a second set of tools are arranged at the proximate and distal ends of the body to rotate into either an “L” mode or “screwdriver” mode for use. A slider engages with an internal spring for switching between two states, a first closed or locked state, retaining the tools in a stored or closed position in which they can not be opened or extended away from the body and a second open or unlocked state, where the tools are “popped-out” and away from the body due to spring forces acting on them, and they are free to be moved or extended into a position, where a 90 degree extension of position would place a tool in an “L” shaped orientation and a 180 degree extension would place a tool in a screwdriver orientation.

### TECHNICAL FIELD OF THE INVENTION

The present invention relates to the field of hand held tools. More specifically, the present invention relates to the field of hexagonal tools and related hand tools.

### BACKGROUND OF THE INVENTION

Hexagonal, Allen, and Torx or starred shaped tools are manufactured and distributed in multiple English and metric sizes. Such tools are usually sold in a set but are also distributed individually. A typical set embodiment includes tools of multiple sizes for either English, metric, or possibly, booth, sometimes connected to a loop, stored in a case with multiple slots for each size, as part of a single unit where they are attached to opposing ends of a body are extended for use with the body acting as the handle for the tool.

In most cases, the tool, to be used efficiently and effectively, such a handheld tool must be able to provide an appropriate number of tool sizes and they must be easily removable from the body for use and just as easy to return to a stored state within or against the body. Many such tools are known in the prior art and they fail from the same shortcomings in that the tool is difficult to grasp and move from a stored position to a usable position either at a perpendicular angle to the tool body being used in an “L” shape, or extended into a “screwdriver” position, where the tool extends in a straight line down the long axis of the tool body. Such a tool, which is difficult for a use to grasp and move the tool with respect to the body creates frustration.

What is needed is a handheld tool that has a body of sufficient length to act as a handle and also provide storage for the tools, which being user friendly in that grasping or moving the tool from a close/stored position is easily done.

### SUMMARY OF THE INVENTION

The present invention is a tool handle for holding multiple tools of different sizes during use. The device is comprised of a body with one or more tools secured to the opposing ends of the body by shoulder screws and screws.

In a first embodiment the device is comprised of a body with one or more tools secured to the opposing ends of the body by shoulder screws and screws. In this embodiment, a two piece slider engages with an internal spring providing means for switching between two states, a first closed or locked state, retaining the tools in a stored or closed position in which they can not be opened or extended into a useful position away from the body and a second open or unlocked state, where the tools are “popped-out” and away from the body due to spring forces acting on them, and they are free to be moved or extended into a position from 0-180 degrees from the longitudinal axis of the body, where a 90 degree extension of position would place a tool in an “L” shaped orientation for use and a 180 degree extension would place a tool in a screwdriver orientation for use.

In a second embodiment, the device is comprised of a two piece body with one or more tools secured to the opposing ends of the body by shoulder screws and screws In this embodiment, a single piece slider engages an internal spring provides means for switching between two states, a first closed or locked state, retaining the tools in a stored or closed position in which they can not be opened or extended into a useful position away from the body and a second open or unlocked state, where the tools are “popped-out” and away from the body due to spring forces acting on them, and they are free to be moved or extended into a position from 0-180 degrees from the longitudinal axis of the body, where a 90 degree extension of position would place a tool in an “L” shaped orientation for use and a 180 degree extension would place a tool in a screwdriver orientation for use.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an expanded view of the device of a first embodiment of the present invention illustrating the body and component parts showing a two piece construction with a third piece comprising a return spring.

FIG. 2 is an expanded view of the device of a second embodiment of the present invention illustrating the body and component parts showing a one piece body with an integral spring.

FIG. 3 is a CAD illustration of the present invention illustrating the sturdy, ergonomic once piece design.

FIG. 4 is a CAD illustration illustrating the auto return slider which “pops-out” keys for easy access.

FIG. 5 is a CAD illustration of the present invention is a screwdriver mode, and teaching where the tools can also be MM and SAE sizes.

FIG. 6 is a CAD illustration of the present invention is a high torque “L” mode.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention is a tool handle for holding multiple tools of different sizes during use. The present invention is unique and non-obvious compared to the prior art in that with the prior art, the sliding collars are external to the body, where the present invention configures the sliders internally. Also, the prior art urges the keys with a manual mode slider, while the present invention enables an automatic mode as described herein and claimed.

The main feature differences/improvements/problems solved by the present invention in comparison to the prior art are the present inventions focus on making the invention a one-handed operation compared to the two handed operation of the prior art. Examples where this aspect is critical is at-height applications where a worker must perform tasks on a ladder while constantly and continuously maintaining three points of contact—one or the other hand, one or the other foot. With hand tools that enable one-handed operation, the at-height worker can access the tools needed without the need to use both hands to grasp, open, access, retract, or stow the given tool:

With the typical prior art devices, the external sliding collars require a two handed operation: one to hold the main body and the other to slide the collar in either direction. The present invention positions the sliders on the left and right sides of the body, and flush to the body. Also, the spring that is positioned between the left and right sliders allows the sliders to return to a center position each time. These three aspects enable a one-handed operation by allowing the user to grasp the body with the fingers and palm while allowing the thumb to actuate the slider in either direction to urge the corresponding key.

In contrast, the typical prior art device's sliding collar is configured to urge several hex keys at the same time, with the same motion. The present invention enables the user to select only the one key that is desired by allowing two separate sliders to move in two directions independently, actuating four separate hex keys individually.

With typical prior art devices, the hex keys are urged by the ramps in the collar from the tip of the keys, therefore user must MANUALLY return the sliding collar back to the center position in order to allow the additional space needed to fit a finger under the hex key to rotate it out of the handle. Unless and until the sliding collar is returned to the center position MANUALLY, the space at the tip of the hex key is constrained by the ramp.

The present invention urges the keys near the pivoting axis of the hex keys (the opposite end of the hex key compared to the prior art), and also due to the combination of the internal slider location and internal return spring, the user is not required to manually return the slider to the center position—therefore enabling an improved AUTOMATIC functionality—(not fully manual like the prior art). Also, due to the location where the hex keys are urged, with the present invention the tip of the selected hex key is positioned proud of the body and its respective channel—further improving the access of the tip of the key for rotating the key using the same one-handed mode as previously described above, and minimizing repositioning of the hand to manipulate the sliders and hex keys.

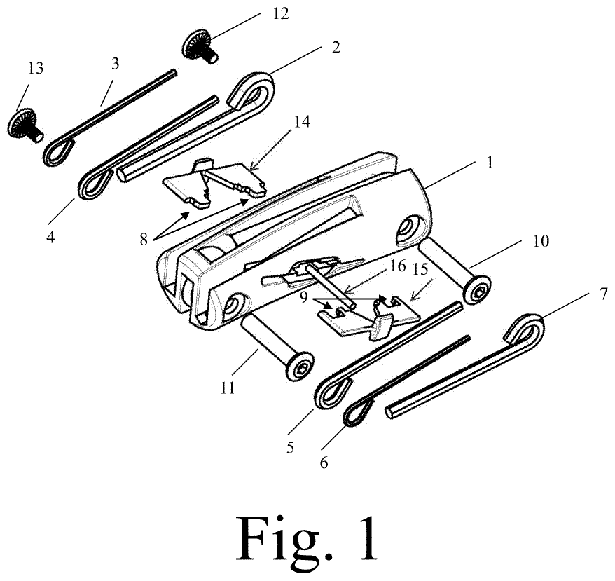

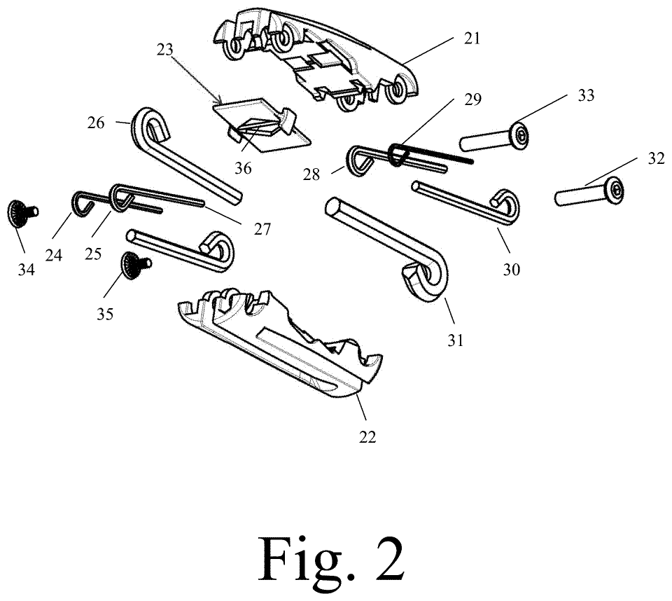

FIG. 1 is an expanded view of the device of a first embodiment of the present invention illustrating a one piece body and internal component parts creating a return spring while FIG. 2 shows a two piece body construction with a one piece internal component comprising a return spring.

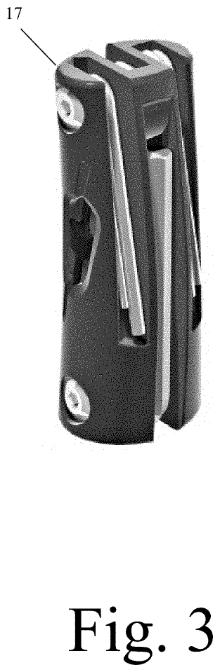

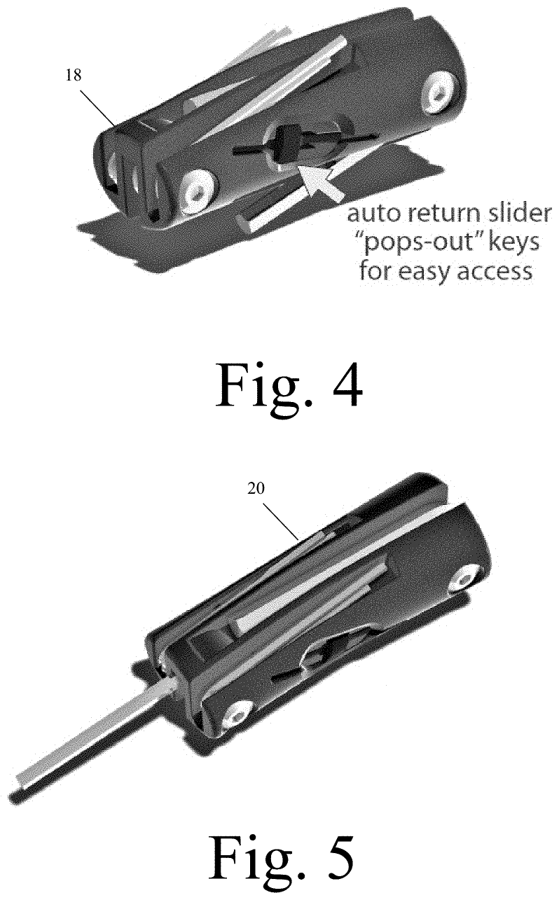

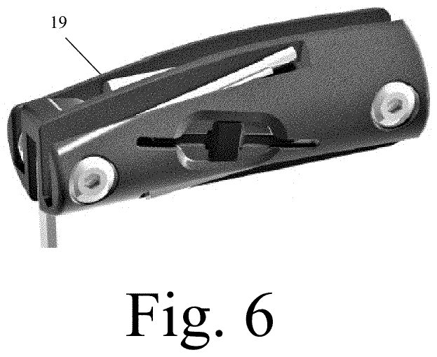

In a first embodiment shown in FIG. 1, the device is comprised of a body 1 with one or more tools 2, 3, 4, 5, 6, 7 secured to the opposing ends of the body by shoulder screws 10, 11 and screws 12, 13. In this embodiment, a two piece slider 14, 15 engages with an internal spring 16 providing means for switching between two states, a first closed or locked state 17, as illustrated by FIG. 3, retaining the tools 2, 3, 4, 5, 6, 7 in a stored or closed position 17 in which they can not be opened or extended into a useful position away from the body 1 and a second open or unlocked state 18, as illustrated by FIG. 4, where the tools 2, 3, 4, 5, 6, 7 are “popped-out” and away from the body 1 due to spring forces acting on them, and they are free to be moved or extended into a position from 0-180 degrees from the longitudinal axis of the body 1, where a 90 degree extension of position would place a tool in an “L” shaped orientation 19 for use as illustrated in FIG. 6 and a 180 degree extension would place a tool in a screwdriver orientation 20 for use as illustrated in FIG. 5.

With the uni-body embodiment as illustrated in FIG. 1, the sliders 14 and 15 comprise features, which are defined as a pair of protrusion 8 on one slider 14 and a corresponding pair or recesses 9 on the other slider 15, the protrusions 8 and matching recesses 9 have the same profile so that the protrusions 8 and recesses 9 of each corresponding slider 14 and 15 interlock with each other when installed within a body cavity, or preferably interlock independently with the body 1, enabling the protrusions 8 and recesses 9 features and corresponding sliders 14 and 15 to move (slide) independently from each other.

FIG. 2 is an expanded view of the device of a second embodiment of the present invention illustrating the body and component parts showing a two piece body 21 and 22 with an integral spring 36.

In a second embodiment shown in FIG. 2, the device is comprised of a two piece body 21 and 22 with one or more tools 24, 25, 26, 27, 28, 29, 30, 31 secured to the opposing ends of the body by shoulder screws 32 and 33 and screws 34 and 35. In this embodiment, a single piece slider 23 engages an internal spring 36 and provides means for switching between two states, a first closed or locked state 17, as illustrated by FIG. 3, retaining the tools in a stored or closed position in which they can not be opened or extended into a useful position away from the body and a second open or unlocked state 18, as illustrated by FIG. 4, where the tools are “popped-out” and away from the body due to spring forces acting on them, and they are free to be moved or extended into a position from 0-180 degrees from the longitudinal axis of the body, where a 90 degree extension of position would place a tool in an “L” shaped orientation 19 for use as illustrated in FIG. 6 and a 180 degree extension would place a tool in a screwdriver orientation 20 for use as illustrated in FIG. 5.

FIG. 3 is a CAD illustration of the present invention illustrating the sturdy, ergonomic once piece design. FIG. 3 illustrates the invention in a stored or closed position in which they can not be opened or extended into a useful position away from the body.

FIG. 4 is a CAD illustration illustrating the auto return slider which “pops-out” keys for easy access. FIG. 4 illustrates the invention in a second open or unlocked state where the tools are “popped-out” and away from the body due to spring forces acting on them, and they are free to be moved or extended into a position from 0-180 degrees from the longitudinal axis of the body, where a 90 degree extension of position would place a tool in an “L” shaped orientation for use as illustrated in FIG. 6 and a 180 degree extension would place a tool in a screwdriver orientation for use as illustrated in FIG. 5.

FIG. 5 is a CAD illustration of the present invention is a screwdriver mode where a 180 degree extension of position places a tool in a screwdriver shaped orientation 20. FIG. 5 also teaches where the tools can also be MM and SAE sizes.

FIG. 6 is a CAD illustration of the present invention is a high torque “L” mode where a 90 degree extension of position places a tool in an “L” shaped orientation 19.

The present invention teaches a generally continuous cylindrical body with a first set of tools and a second set of tools are arranged at the proximate and distal ends of the body to rotate in a specific alternating 180 degree sequence in either an “L” mode or “screwdriver” mode for use. The tools are configured to be positioned at one or more hinge points by screws and shoulder screws. At a proximal end of the tool body and at the tangent of the circumference of the body at the distal end of each tool; each tool is configured to rotate away from the body to a plurality of angles.

The general cylindrical body also provides angled channels or walls with varying angular depths or tool slots where the tools are arranged and retained within the general cylindrical body. The distal end of each tool is tangent to the circumference of the body.

The unique orientation of each tool within the angled channels is so that the overall shape of the body is generally cylindrical: The present invention is distinguished as an item that comprises specific, unique, and individual angle orientations for each tool, as well as specific alternating and individual rotational directions for each tool for the purpose of avoiding large channel interruptions within a generally continuous cylindrical shape, while at the same time teach that these multiple angles combined with strictly alternating rotation, minimize the width of each of these channels. Each tool is positioned at an angle such that the working (distal) end sits at the tangent to the circumference of the body.

Also, unlike the prior art, since each tool varies in size and length, no two tool angles are the same. In the prior art, groups of tools are parallel to each other and also parallel to the central longitudinal axis. Also, in the present invention the tools do not rotate in a plurality of directions as comprised in the prior art, but rotate in a specific alternating sequence around a common axis.

The prior art comprises groups of tools within each channel. The new invention comprises single tools within a single channel, and/or multiple of only the smallest tools within a single channel. The purpose is to minimize the width of each channel and therefore minimize the surface interruptions to the generally continuous cylindrical shape of the body.

Each channel is set at a varying angular depths from the proximal end of each tool to the distal end of each tool, unlike the prior art. The prior art comprises sets of tools within sets of channels that are parallel to the central longitudinal axis of the body. This arrangement precludes minimizing the widths of the channels as well as precluding minimizing the depth of each channel. Since the width of each channel is defined by the number of tools grouped side by side within each channel, then the width cannot be confined to the width of individual tool as in the new invention.

Also, since the depth of each channel of the prior art is defined by the maximum diameter of the largest tool within each group of tools combined with the fact that the channels are parallel to the central longitudinal axis, then each individual channel must be as deep as the largest tool within each group, unlike the new invention. The depth and the width of the channels of the prior art combine to create very large interruptions in a shape that does not achieve a generally cylindrical shape due to these factors.

Additionally, each tool alternates its orientation on the hinge: the largest in the center, and then alternating smaller sizes on either side. The reason is to balance the sizes of each channel around the circumference so that the channels do not become excessively large and interrupt the generally continuous cylindrical surface of the body.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A utility tool comprising:
a generally continuous cylindrical body with one or more tools secured to the opposing ends of the body by shoulder screws and screws;
a two piece slider engages with an internal spring providing means for switching between two states;
the sliders are further comprised of a set of protrusion and recess features that interlock with each other when installed or preferably interlock independently with the body, enabling the features and corresponding sliders to move (slide) independently from each other,
a first closed or locked state, retaining the tools in a stored or closed position in which they can not be opened or extended into a useful position away from the body; and
a second open or unlocked state, where the tools are “popped-out” and away from the body due to spring forces acting on them and they are free to be moved or extended into a position from 0-180 degrees from the longitudinal axis of the body,
where a 90 degree extension of position would place a tool in an “L” shaped orientation for use; and
a 180 degree extension would place a tool in a screwdriver orientation for use as illustrated in FIG. 5.

2. The utility tool of claim 1, wherein the body is of one piece construction.

3. The utility tool of claim 1, wherein the body is of a two piece construction.

4. The utility tool of claim 1, wherein the spring auto returns the slider back to its center position after being moved to either side of its range of motion to release the tools.

5. The utility tool of claim 1, wherein
the tools can be a tool or wrench;
the tool can be hexagonal, round, or square in shape, or any plurality of shape combinations including MM and SAE.

6. The utility tool of claim 1, wherein
the general cylindrical body also provides angled channels or walls with varying angular depths or tool slots where the tools are arranged and retained within the general cylindrical body.

7. The utility tool of claim 1, wherein
the distal end of each tool is tangent to the circumference of the body; and
tools are arranged perpendicular to the central longitudinal axis of the body in order to specifically reduce the number of screws required to assemble the unit from four, to one with a mating nut.

8. The utility tool of claim 1, further comprising only one axis per end, of which all tools are assembled around.

9. The utility tool of claim 1, wherein
each tool alternates its orientation on the hinge: the largest in the center, and then alternating smaller sizes on either side.

10. The utility tool of claim 1, wherein
the body can be molded so that the exterior shape of the body, when in a closed position, is substantially circular almost a teardrop or rounded triangular shape, pentagonal, hexagonal, or circular.

11. A utility tool comprising:
a generally continuous cylindrical body with one or more tools secured to the opposing ends of the body by shoulder screws and screws;
a one piece slider engages with an internal spring providing means for switching between two states,
a first closed or locked state, retaining the tools in a stored or closed position in which they can not be opened or extended into a useful position away from the body; and
a second open or unlocked state, where the tools are “popped-out” and away from the body due to spring forces acting on them and they are free to be moved or extended into a position from 0-180 degrees from the longitudinal axis of the body,
where a 90 degree extension of position would place a tool in an “L” shaped orientation for use; and
a 180 degree extension would place a tool in a screwdriver orientation for use as illustrated in FIG. 5.

12. The utility tool of claim 11, wherein the body is of one piece construction.

13. The utility tool of claim 11, wherein the body is of a two piece construction.

14. The utility tool of claim 11, wherein the spring auto returns the slider back to its center position after being moved to either side of its range of motion to release the tools.

15. The utility tool of claim 11, wherein
the tools can be a tool or wrench;
the tool can be hexagonal, round, or square in shape, or any plurality of shape combinations including MM and SAE.

16. The utility tool of claim 11, wherein
the general cylindrical body also provides angled channels or walls with varying angular depths or tool slots where the tools are arranged and retained within the general cylindrical body.

17. The utility tool of claim 11, wherein
the distal end of each tool is tangent to the circumference of the body; and
tools are arranged perpendicular to the central longitudinal axis of the body in order to specifically reduce the number of screws required to assemble the unit from four, to one with a mating nut.

18. The utility tool of claim 11, further comprising only one axis per end, of which all tools are assembled around.

19. The utility tool of claim 11, wherein
each tool alternates its orientation on the hinge: the largest in the center, and then alternating smaller sizes on either side.

20. The utility tool of claim 11, wherein
the body can be molded so that the exterior shape of the body, when in a closed position, is substantially circular almost a teardrop or rounded triangular shape, pentagonal, hexagonal, or circular.
